(19) United States
(12) Patent Application Publication
(10) Pub. No.: US 2019/0170569 A1
(43) Pub. Date: Jun. 6, 2019

(54) VIBRATION MONITORING SYSTEM

(71) Applicant: Caterpillar Paving Products Inc., Brooklyn Park, MN (US)

(72) Inventors: Nicholas Alan Oetken, Brooklyn Park, MN (US); Derek Kenneth Huhn, Monticello, MN (US)

(73) Assignee: Caterpillar Paving Products Inc., Brooklyn Park, MN (US)

(21) Appl. No.: 15/832,874

(22) Filed: Dec. 6, 2017

(51) Int. Cl. G01H 1/00; G08B 21/18; G08B 7/06

(52) U.S. Cl. CPC G01H 1/00; G08B 7/06; G08B 21/182

(57) ABSTRACT

A vibration monitoring system at a work site is provided. The vibration monitoring system includes a vibration detection sensor associated with a structure provided at the work site. The vibration detection sensor is configured to generate a signal indicative of vibrations in an area proximate to the structure. The system includes a stationary alert assembly provided at the work site. The stationary alert assembly is proximate to the structure and the stationary alert assembly is positioned such that an alert provided by the stationary alert assembly is perceivable by users operating at the work site. The system also includes a controller coupled to the vibration detection sensor and the stationary alert assembly. The controller is configured to receive the signal indicative of the vibrations and compare the signal with a predetermined threshold. The controller is configured to provide the alert to the users through the stationary alert assembly based on the comparison.

### TECHNICAL FIELD

The present disclosure relates to a vibration monitoring system, and more specifically, to a system and method for monitoring vibrations at a work site.

### BACKGROUND

Machines, such as vibratory compactors, are used in a variety of applications to compact various materials. The primary role of the compactor is to compact these materials to a desired density. Vibrations generated from operating these machines is beneficial for compaction. However, these vibrations may be detrimental to sensitive structures that are present at a work site.

Currently, it may be difficult for site managers or supervisors to measure these vibrations and provide real-time feedback to operators of the machine. While operating the machines at the work site, the operators may in some cases unknowingly exceed recommended vibration levels, affecting the sensitive structures present at the work site.

United States Published Application Number 2010/0008728 describes a compactor. The compactor includes a transporter, an impact tool, a lifting mechanism capable of lifting the impact tool to a raised position, a substantially elongate support mast coupled to the lifting mechanism and capable of supporting the raised impact tool, and a mast stabilization system characterized in that the stabilizing system is capable of adjusting the orientation of the support mast to allow the impact tool to descend substantially vertically from said raised position without the transmission of any lateral force by the tool to the support mast.

### SUMMARY OF THE DISCLOSURE

In one aspect of the present disclosure, a vibration monitoring system at a work site is provided. The vibration monitoring system includes a vibration detection sensor associated with a structure provided at the work site. The vibration detection sensor is configured to generate a signal indicative of vibrations in an area proximate to the structure. The system also includes a stationary alert assembly provided at the work site. The stationary alert assembly is proximate to the structure and the stationary alert assembly is positioned such that an alert provided by the stationary alert assembly is perceivable by users operating at the work site. The system also includes a controller coupled to the vibration detection sensor and the stationary alert assembly. The controller is configured to receive the signal indicative of the vibrations and compare the signal with a predetermined threshold. The controller is configured to provide the alert to the users through the stationary alert assembly based on the comparison.

In another aspect of the present disclosure, a method for vibration monitoring at a work site is provided. The method includes receiving, by a controller, a signal indicative of the vibrations in an area proximate to a structure through a vibration detection sensor. The method includes comparing, by the controller, the signal with a predetermined threshold. The method includes providing, by the controller, an alert to the users through a stationary alert assembly based on the comparison. The stationary alert assembly is proximate to the structure and is positioned such that the alert provided by the stationary alert assembly is perceivable by users operating at the work site.

In yet another aspect of the present disclosure, a system for vibration monitoring at a work site including a plurality of structures is provided. The system includes a vibration detection sensor associated with each of the plurality of structures provided at the work site. The vibration detection sensor is configured to generate a signal indicative of vibrations in an area proximate to the respective structure. The system also includes a stationary alert assembly associated with each of the plurality of structures. The stationary alert assembly is positioned proximate to the respective structure such that an alert provided by the stationary alert assembly is perceivable by users operating at the work site. The system also includes a controller coupled to the vibration detection sensor and the stationary alert assembly. The controller is configured to receive the signal indicative of the vibrations for each of the plurality of structures. The controller is configured to compare the signal with a predetermined threshold. The controller is configured to provide the alert to the users through the respective stationary alert assembly based on the comparison.

Other features and aspects of this disclosure will be apparent from the following description and the accompanying drawings.

### BRIEF DESCRIPTION OF THE DRAWINGS

FIG. 1 is a schematic view of an exemplary work site, in accordance with the concepts of the present disclosure;

FIG. 2 is a block diagram of a vibration monitoring system for the work site of FIG. 1, in accordance with the concepts of the present disclosure; and

FIG. 3 is a flowchart of a method for monitoring vibrations at the work site, in accordance with the concepts of the present disclosure.

### DETAILED DESCRIPTION

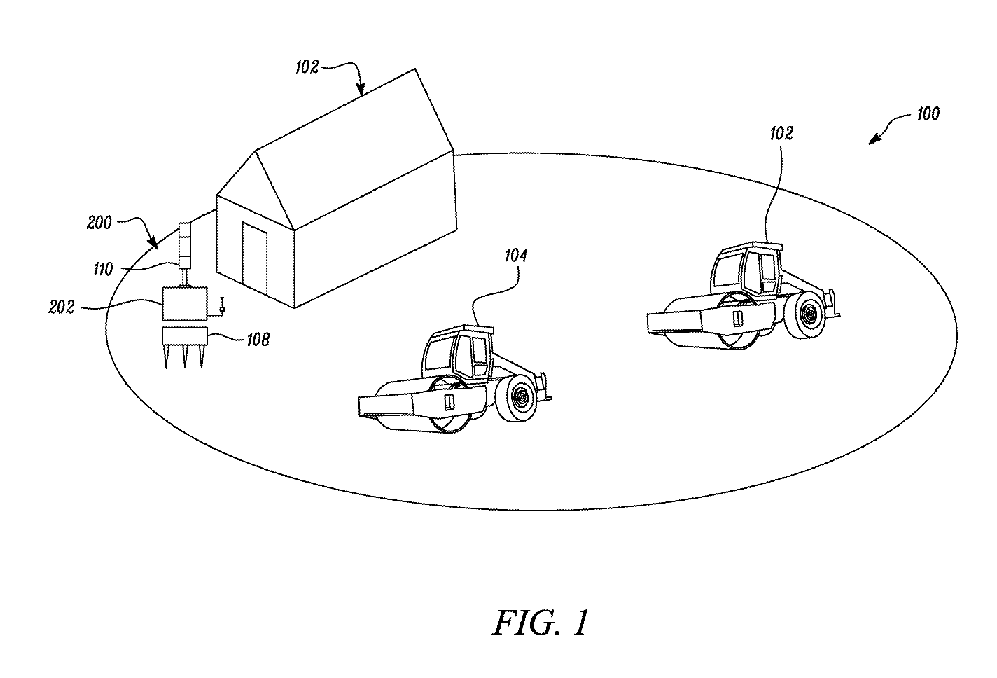

Referring to FIG. 1, an exemplary work site 100 is illustrated. The work site 100 may be any known mining job site. A number of machines 102, 104 operate at the work site 100 100. In the illustrated embodiment, compactors are shown operating at the work site 100. Alternatively, any other types of machines may operate at the work site 100 without any limitation. For simplicity of explanation, two compactors are shown in the accompanying figures. However, the number of machines 102, 104 present at the work site 100 may vary without any limitation.

The work site 100 also includes a structure 106. In the present disclosure, the structure 106 represents a building or any other construction that is present at the work site 100 and requires protection from vibrations generated by the machines 102, 104 during operation. For simplicity, a single structure 106 is shown at the work site 100. However, the number of structures 106 present at the work site 100 may vary without any limitation. Further, based on the type of the structure 106, each structure 106 at the work site 100 has a predetermined vibration level or predetermined threshold associated with a given area surrounding the structure 106. During operation, if the vibrations at the work site 100 exceed the predetermined threshold for the structure 106, the respective structure 106 may be potentially affected by the vibrations.

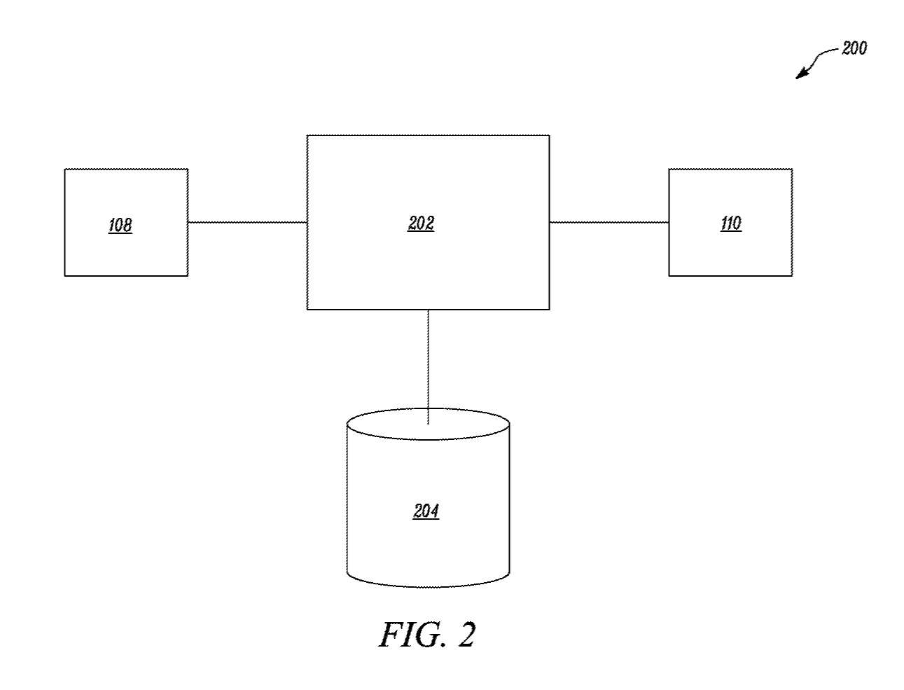

The present disclosure relates to a vibration monitoring system 200 associated with the work site 100. Referring to FIGS. 1 and 2, the vibration monitoring system 200 includes a vibration detection sensor 108 provided at the work site. The vibration detection sensor 108 is associated with the structure 106. A number of vibration detection sensors 108 are provided on the work site 100 proximate to respective structures 106. The vibration detection sensor 108 is positioned at the work site 100 such that the vibration detection sensor 108 is proximate to the structure 106, and is configured to generate a signal indicative of vibrations in the area surrounding the structure 106.

As explained earlier, these vibrations may be generated due to operation of the machines 102, 104 at the work site 100. In one example, the vibration detection sensor 108 is a geophone. Alternatively, the vibration detection sensor 108 may include any other similar device to measure the ground vibration and calculating the vibration levels or particle velocities. In one example, one or more vibration detection sensors 108 may be positioned in the area surrounding the structure 106 for measuring the vibrations in the area.

Additionally, stationary alert assemblies 110 are provided at different locations on the work site 100. More specifically, one or more stationary alert assemblies 110 may be placed in the area surrounding the respective structure 106. The stationary alert assemblies 110 are fixedly provided at the work site 100 such that alerts provided by the stationary alert assembly 110 are perceivable by the operators, personnel and/or users present on the work site 100. The alerts provided by the stationary alert assembly 110 may include visual alerts, audio alerts or a combination thereof and will be explained later in this section. It should be noted that the stationary alert assembly 110 is a stationary and relatively large device that is fixedly attached to the work site 100 and can be viewed or heard easily from any location at the work site 100 or within a defined vicinity at the work site 100.

The vibration monitoring system 200 also includes a controller 202. The controller 202 is coupled to the vibration detection sensor 108. The controller 202 is configured to receive the signal indicative of the vibrations in the area surrounding the structure 106 from the vibration detection sensor 108. Further, the controller 202 is coupled to a database 204. The database 204 may include any known data repository or memory storage device for storing information related to the predetermined threshold associated with the structure 106. The controller 202 is configured to access and retrieve the predetermined threshold from the database 204. The controller 202 then compares the signal received from the vibration detection sensor 108 and the predetermined threshold. If the current vibrations in the area surrounding the structure 106 exceed the predetermined threshold, the controller 202 is configured to provide the alert through the stationary alert assembly 110.

As mentioned above, the alert may be any combination of visual and/or audio alerts. In one embodiment, based on a degree of closeness between the signal indicative of the current vibrations and the predetermined threshold, different alerts may be provided through the stationary alert assembly 110. For example, as shown in FIG. 1, the stationary alert assembly 110 may include a set of lights, say three lights. If the signal lies within a first range of the predetermined threshold, a first alert, say a green light, is made visible for all operators at the work site to see. Further, if the signal lies within a second range of the predetermined threshold, a second alert, say an orange light is made visible for all operators at the work site to see if the signal lies within a third range of the predetermined threshold, a third alert, say a combination of a red light and an alarm is provided by the stationary alert assembly 110 for all operators at the work site. The alerts described above are exemplary and do not limit the scope of the present disclosure.

The alerts are provided by the stationary alert assembly 110 in such a manner that the alerts can be seen or heard by all operators at the work site 100 and/or within the predefined vicinity of the structure 106, so that the operators may take the required corrective actions on perceiving the alert. Additionally, the stationary alert assembly 110 is positioned near the respective structure 106 so that the operator is made aware which structure 106 is potentially at risk. The controller 202 is configured to provide the alert on a real-time basis.

In one example, the controller 202, the vibration detection sensor 108, and the stationary alert assembly 110 are integrated into a single device and installed proximate to the structure 106 at the work site 100, such that the controller 202 within the device processes and analyses the vibration data for the given structure 106. Alternatively, the stationary alert assembly 110 and the vibration detection sensor 108 may be placed in a single device near the structure 106, and the controller 202 may be located off-site. In one example, the controller 202 may receive and process data from multiple vibration detection sensors 108 through known wireless communication techniques. In yet another embodiment, each of the vibration detection sensor 108, the stationary alert assembly 110, and the controller 202 may be individual and separate components that are installed and positioned at different locations and may communicate with one another using known communication networks.

Additionally, in some cases the controller 202 may also be configured to provide another alert on mobile devices, that have authorized access, in addition to the alert provided by the stationary alert assembly 110. Also, the data collected from the multiple vibration detection sensors 108 may also be stored in a cloud or other known storage device for later retrieval by the controller 202.

The controller 202 may be a microprocessor or other processor as known in the art. The controller 202 may embody a single microprocessor or multiple microprocessors to perform the operations described above. Numerous commercially available microprocessors may be configured to perform the functions of the controller 202. A person of ordinary skill in the art will appreciate that the controller 202 may additionally include other components and may also perform other functions not described herein.

### INDUSTRIAL APPLICABILITY

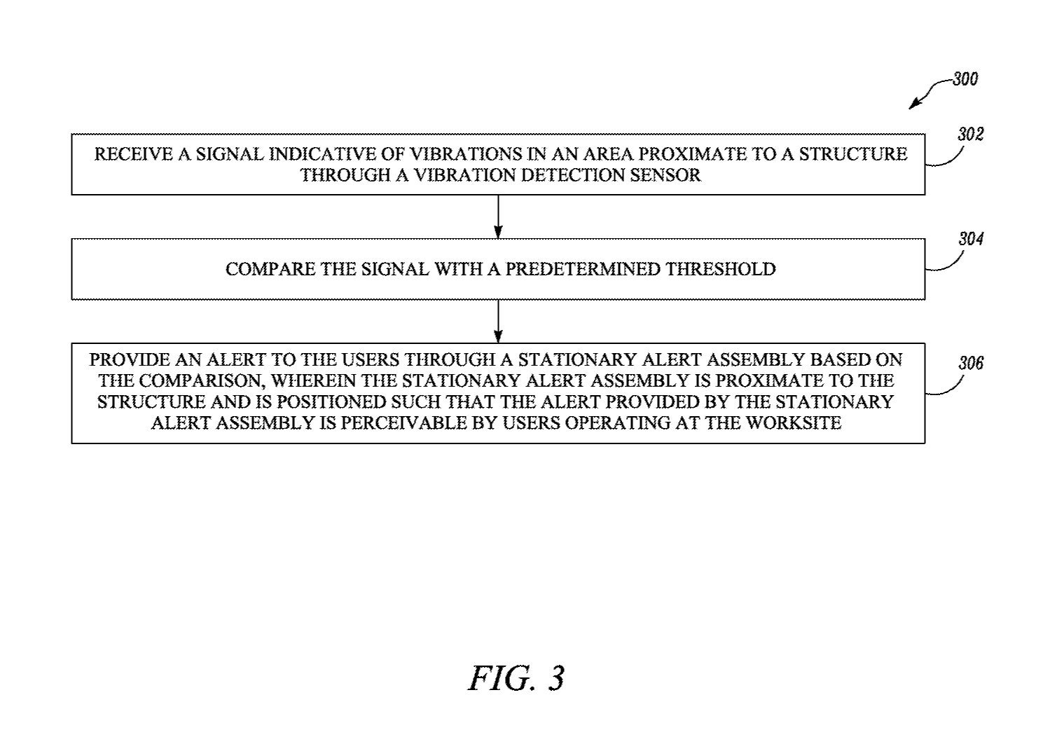

The present disclosure provides the system 200 and method 300 for monitoring vibrations generated at a work site 100. Referring to FIG. 3, at step 302, the controller 202 receives the signal indicative of the vibrations in the area proximate to the structure 106 through the vibration detection sensor 108. At step 304, the controller 202 compares the signal with the predetermined threshold. At step 306, the controller 202 provides the alert to the users through the stationary alert assembly 110 based on the comparison. The stationary alert assembly 110 is proximate to the structure 106 and is positioned such that the alert provided by the stationary alert assembly 110 is perceivable by the users operating at the work site 100.

The stationary alert assembly 110 of the present disclosure provides as easy and cost-effective solution for identifying if the vibrations generated in the area of the work site 100 are detrimental to given structures 106 present on the work site 100. The system may be easily deployed by providing the suitable hardware at the desired locations of the work site 100. The stationary alert assembly 110 can be installed proximate to the structure 106 and can be viewed or heard by all operators in the defined vicinity of the work site 100. This may make it easy for operators to become aware of when the vibrations in the area are high enough to cause potential damage to the structures 106, allowing the operators to take corrective actions in time.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A vibration monitoring system at a work site, the vibration monitoring system comprising:
a vibration detection sensor associated with a structure provided at the work site, the vibration detection sensor configured to generate a signal indicative of vibrations in an area proximate to the structure;
a stationary alert assembly provided at the work site, wherein the stationary alert assembly is proximate to the structure and the stationary alert assembly is positioned such that an alert provided by the stationary alert assembly is perceivable by users operating at the work site; and
a controller coupled to the vibration detection sensor and the stationary alert assembly, wherein the controller is configured to:
receive the signal indicative of the vibrations;
compare the signal with a predetermined threshold; and
provide the alert to the users through the stationary alert assembly based on the comparison.

2. The vibration monitoring system of claim 1, wherein the vibration detection sensor is a geophone.

3. The vibration monitoring system of claim 1, wherein the stationary alert assembly provides at least one of a visual and an auditory output.

4. The vibration monitoring system of claim 1, wherein the stationary alert assembly includes a set of lights provided proximate to the structure, such that the lights are viewable by the users operating at the work site.

5. The vibration monitoring system of claim 1, wherein the vibration detection sensor, the stationary alert assembly, and the controller are provided in a single integrated unit proximate to the structure at the work site.

6. The vibration monitoring system of claim 1, wherein the controller is configured to provide a number of different alerts through the stationary alert assembly based on a degree of closeness between the signal and the predetermined threshold.

7. The vibration monitoring system of claim 1, wherein the controller is configured to provide a first alert through the stationary alert assembly if the signal lies within a first range of the predetermined threshold, and wherein the controller is configured to provide a second alert through the stationary alert assembly if the signal lies within a second range of the predetermined threshold, such that a first alert is a visual alert provided through the stationary alert assembly and the second alert is an auditory alert provided through the stationary alert assembly.

8. The vibration monitoring system of claim 1, wherein the controller is configured to provide the alert on a real-time basis.

9. The vibration monitoring system of claim 1, wherein the controller is configured to receive the signals from a number of the vibration detection sensors each associated with the structure at the work site.

10. A method for vibration monitoring at a work site, the method comprising:
receiving, by a controller, a signal indicative of the vibrations in an area proximate to a structure through a vibration detection sensor;
comparing, by the controller, the signal with a predetermined threshold; and
providing, by the controller, an alert to the users through a stationary alert assembly based on the comparison, wherein the stationary alert assembly is proximate to the structure and is positioned such that the alert provided by the stationary alert assembly is perceivable by users operating at the work site.

11. The method of claim 10 further including providing at least one of a visual and an auditory output through the stationary alert assembly.

12. The method of claim 10 further including activating, by the controller, one of a plurality of lights of the stationary alert assembly based on the comparison wherein the stationary alert assembly includes a set of lights provided proximate to the structure, such that the lights are viewable by the users operating at the work site.

13. The method of claim 10, wherein the vibration detection sensor, the stationary alert assembly, and the controller are provided in a single integrated unit proximate to the structure at the work site.

14. The method of claim 10 further including providing a number of different alerts through the stationary alert assembly based on a degree of closeness between the signal and the predetermined threshold.

15. The method of claim 10 further including providing a first alert through the stationary alert assembly if the signal lies within a first range of the predetermined threshold, and providing a second alert through the stationary alert assembly if the signal lies within a second range of the predetermined threshold, such that a first alert is a visual alert provided through the stationary alert assembly and the second alert is an auditory alert provided through the stationary alert assembly.

16. The method of claim 10 further including providing the alert on a real-time basis.

17. The method of claim 10 further including receiving the signals from a number of the vibration detection sensors each associated with the structure at the work site.

18. A system for vibration monitoring at a work site including a plurality of structures, the system comprising:
a vibration detection sensor associated with each of the plurality of structures provided at the work site, the vibration detection sensor configured to generate a signal indicative of vibrations in an area proximate to the respective structure;
a stationary alert assembly associated with each of the plurality of structures, wherein the stationary alert assembly is positioned proximate to the respective structure such that an alert provided by the stationary alert assembly is perceivable by users operating at the work site; and
a controller coupled to the vibration detection sensor and the stationary alert assembly, wherein the controller is configured to:
receive the signal indicative of the vibrations for each of the plurality of structures;
compare the signal with a predetermined threshold; and
provide the alert to the users through the respective stationary alert assembly based on the comparison.

19. The system of claim 18, wherein the vibration detection sensor is a geophone.

20. The system of claim 18, wherein the stationary alert assembly provides at least one of a visual and an auditory output.
